(19) United States
(12) Patent Application Publication
(10) Pub. No.: US 2006/0093331 A1
(43) Pub. Date: May 4, 2006

(54) Audio decoding system with a ring buffer and its audio decoding method

(75) Inventors: Chin-Ming Huang, Bade City (TW); Yu-Chi Chen, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/229,511

(22) Filed: Sep. 20, 2005

(30) Foreign Application Priority Data
Nov. 3, 2004 (TW) 093133532

(51) Int. Cl. H04N 5/781

(52) U.S. Cl. 386/96; 386/125

(57) ABSTRACT

An audio decoding system with a ring buffer, which receives an audio stream and maintains it in synchronization. The audio stream has multiple basic decoding units. The system includes a ring buffer, a parser and a decoder. The parser can align start positions of a basic decoding unit and the ring buffer based on features of the audio stream and a synchronization mechanism implied in the start position of the ring buffer such that auto-synchronization is performed even when the audio stream has transmission errors to thus cause data increase or reduction.

### BACKGROUND OF THE INVENTION

1. Field of the Invention

The invention relates to the technical field of audio decoding and, more particularly, to an audio decoding system with a ring buffer and its audio decoding method.

2. Description of Related Art

FIG. 1 is a block diagram of a DVD player 100, which includes a user interface 28, a control module 29, a main controller 21, a demultiplexer 22, an audio decoder 231, a video decoder 232, an audio post-processor 24, an audio output unit 25, a video post-processor 26 and a video output unit 27. The DVD player 100 applies an optical reader (not shown) to read data (audio/video stream) recorded in a compact disk (not shown). The audio/video stream read is subjected by the main controller 21 to the demultiplexer 22. The demultiplexer 22 divides the audio/video stream into a video stream and an audio stream for output to the video decoder 232 and the audio decoder 231 respectively. The video stream decoded is post-processed by the video post-processor 26. Accordingly, the video output unit 27 can display image frames on a screen (not shown). The audio stream decoded is post-processed by the audio post-processor 24. Accordingly, the audio output unit 25 can play sounds through a speaker (not shown) or output audio data to an external decoder. A user can control various functions provided by the DVD player 100 through the user interface 28.

A typical audio decoder 231 can decode the audio stream with a format of AC3, MPEG Audio or Linear Pulse Code Modulation (LPCM). Such an audio stream consists of audio packs. FIG. 2 is a format of an LPCM audio pack, which includes a pack header 210 and an LPCM audio packet 220. The LPCM audio packet 220 contains a packet header 221, an LPCM associated information 222 and an LPCM audio data 223. The LPCM associated information 222, as shown in FIG. 3, contains corresponding information of the LPCM audio packet, wherein an 8-bit Number_of_frame_headers field indicates how many first bytes of audio frames are included in the LPCM audio packets 220, and a First_access_unit_pointer 16-bit field indicates where the first audio frame is located in the LPCM audio packet 220.

The LPCM audio data 223, as shown in FIG. 4, consists of groups of audio frames (GOFs). A GOF contains 20 audio frames, each having 1/600 second audio sampling data (i.e., 80 samples at 48 kHz sampling frequency, 160 samples at 96 kHz sampling frequency). The alignment of audio sampling data is shown in FIG. 5, which is arranged by sampling and channel sequences to thus obtain three types of 16, 20, 24 bits at a same sampling point.

Referring to FIG. 5, the LPCM stream cannot ensure stream synchronization by finding frame header which doesn't exist in LPCM audio stream. Due to the alignment of LPCM audio sampling data in the LPCM audio stream, in case of no appropriate synchronization mechanism, when the stream has errors or damages to thus cause data increase or reduction, the audio sampling data may be unaligned so as to lead to mistake decode.

To overcome this, U.S. Pat. No. 6,334,026 discloses a four to ten bit synchronization word inserted in front of each LPCM audio pack. In this case, an audio decoder starts to work after finding a correct synchronization word, thereby keeping the audio decoder and the LPCM stream in synchronous by means of inserting the synchronization word.

However, by means of inserting the synchronization word, it can effectively keep in synchronous but also increase stream amount and transmission bandwidth. In addition, synchronous failure may cause the audio decoder to malfunction in decoding. Therefore, it is desirable to provide an improved LPCM audio decoder and method to mitigate and/or obviate the aforementioned problems.

### SUMMARY OF THE INVENTION

The object of the invention is to provide an audio decoding system with a ring buffer and its audio decoding method, which can maintain an audio decoder and an audio stream in synchronous.

According to a feature of the invention, an audio decoding system with a ring buffer is provided, which receives an audio stream and maintains it in synchronization. The audio stream includes multiple basic decoding units. The system includes a ring buffer, a parser and a decoder. The ring buffer stores the multiple basic decoding units. The parser parses the audio stream to produce the multiple basic decoding units in successive and writes the basic decoding units produced to the ring buffer one by one. A start position of the first basic decoding unit in the ring buffer is aligned at a start position of the ring buffer. An end position of the ring buffer is dynamically adjusted such that the ring buffer has a length which is a multiple of a data length of a basic decoding unit. After adjustment, the end position of the ring buffer is output to the decoder. Accordingly, the decoder successively reads the basic decoding units from the start position of the ring buffer to the end position for sound decoding.

According to another feature of the invention, an audio decoding method is provided, which receives an audio stream and maintains it in synchronization. The audio stream includes multiple basic decoding units. A ring buffer is used to temporarily store the basic decoding units. The method include a parsing step and a decoding step. The parsing step parses the audio stream to produce the multiple basic decoding units in successive and writes the basic decoding units produced to the ring buffer one by one. A start position of the first basic decoding unit in the ring buffer is aligned at a start position of the ring buffer. An end position of the ring buffer is dynamically adjusted such that the ring buffer has a length which is a multiple of a data length of a basic decoding unit. After adjustment, the end position of the ring buffer is output to a decoder. The decoding step accordingly uses the decoder to successively read the basic decoding units from the start position of the ring buffer to the end position and decode each basic decoding unit read.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical DVD player;

FIG. 2 is a schematic diagram of a typical format of an LPCM audio pack;

FIG. 3 is a schematic diagram of a typical LPCM associated information field;

FIG. 4 is a schematic diagram of groups of LPCM audio frames;

FIG. 5 is a schematic diagram of a typical alignment of an audio sampling data;

FIG. 6 is a block diagram of an audio decoding system with a ring buffer according to the invention;

FIG. 7 is a schematic diagram of an operation of FIG. 6 according to the invention;

FIG. 8 is a flowchart of an audio decoding method according to the invention; and

FIG. 9 is a schematic diagram of WAVE associated information fields according to the invention.

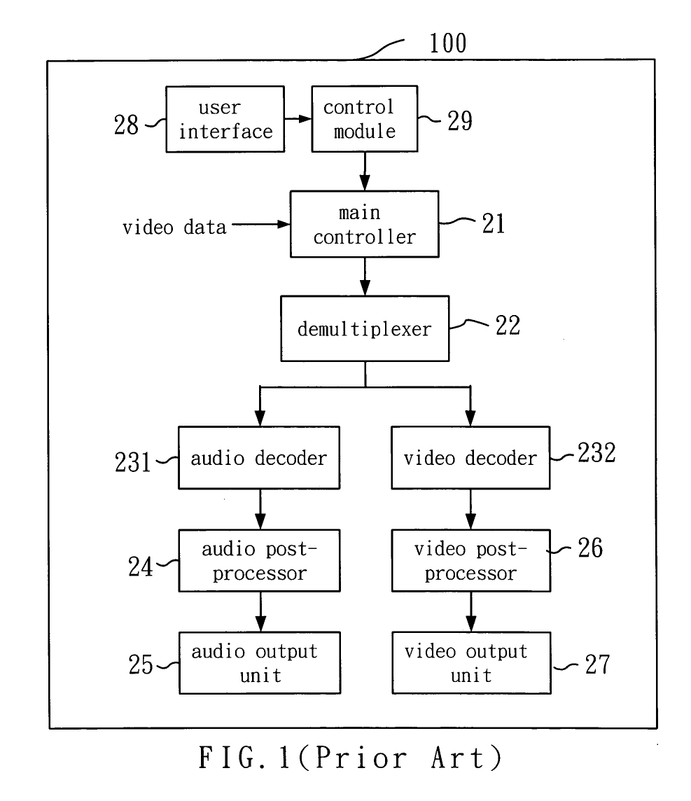

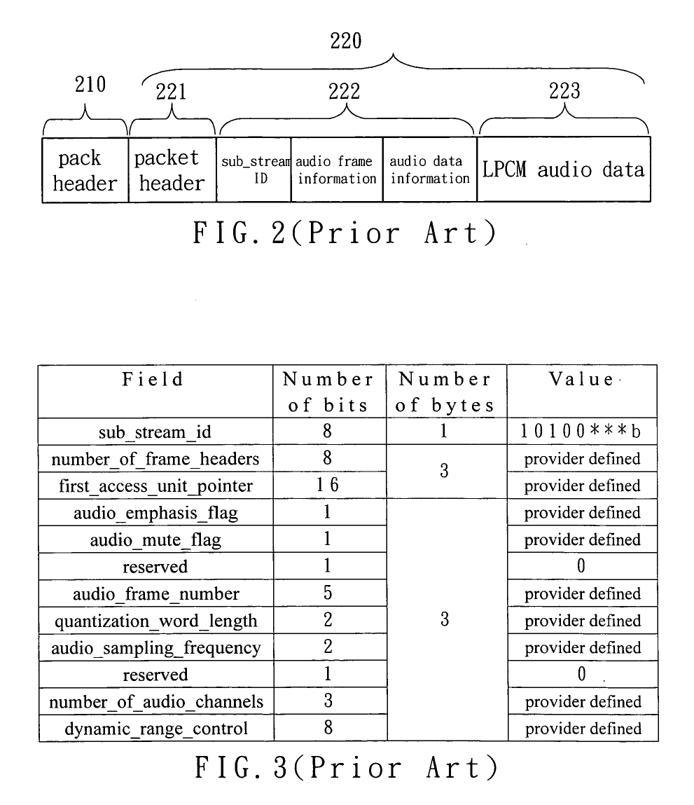

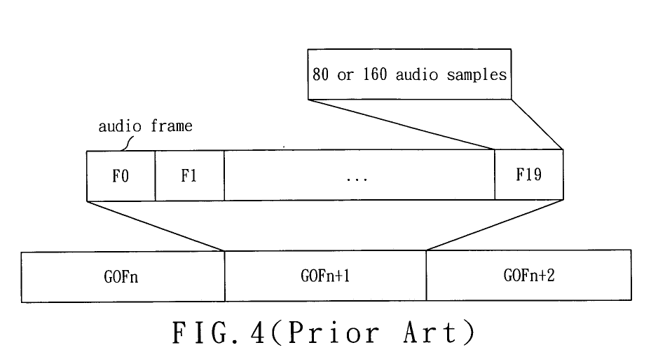

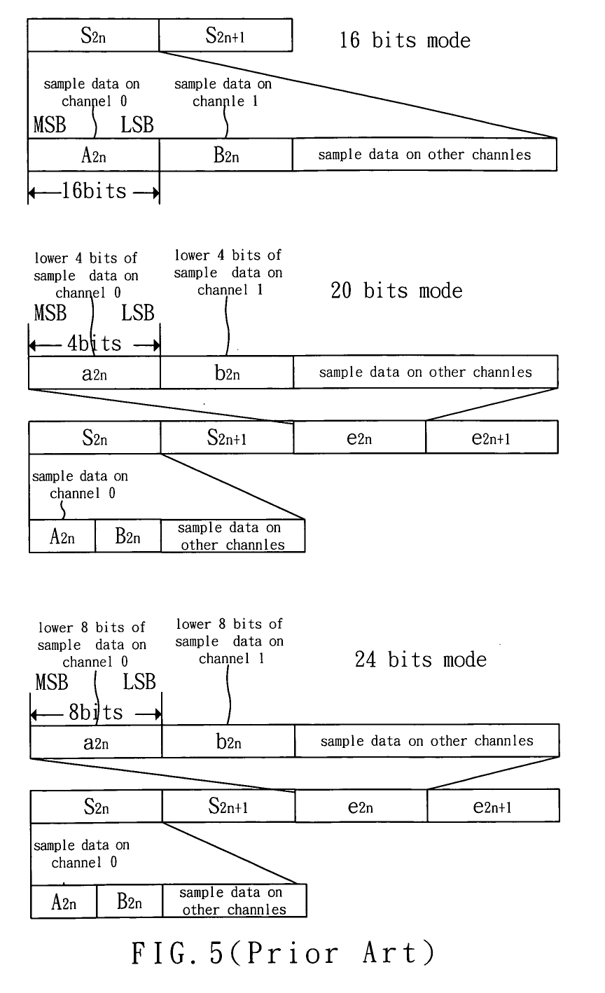

### DETAILED DESCRIPTION OF THE PREFERRED EMBODIMENT

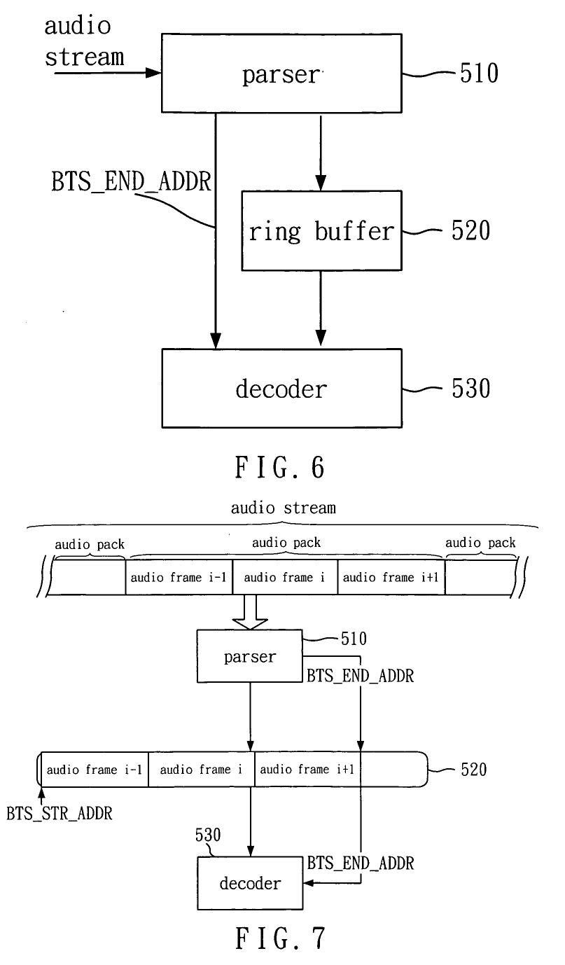

FIG. 6 is a block diagram of an audio decoding system with a ring buffer according to the invention, which receives an audio stream and maintains it in synchronization. The audio stream is a format of Linear Pulse Code Modulation (LPCM) and consists of multiple audio packets in successive. Each audio packet has multiple complete or partial audio frames. An audio frame is regarded as a basic decoding unit. The audio decoding system includes a ring buffer 520, a parser 510 and a decoder 530.

FIG. 7 is a schematic diagram of an operation of FIG. 6 according to the invention. Referring to FIGS. 6 and 7, the ring buffer 520 stores multiple audio frames, which uses a BTS_STR_ADDR signal to record a start position of the multiple audio frames stored, a BTS_END_ADDR signal to record an end position of the multiple audio frames stored and a BTS_MAX_LEN signal to record a maximum length of the ring buffer 520.

The parser 510 receives the audio stream and parses the LPCM associated information 222 included in the audio stream to thus generate the multiple audio frames in successive. The parser 510 sets corresponding decoding parameters, such as quantization_word_length, audio_sampling_frequency, number_of_audio_channels, etc, in the decoder 530 and writes the audio frames produced in the ring buffer 520 one by one. First audio frame i−1 is filled in a position recorded by the BTS_STR_ADDR signal, wherein a start position of which is aligned to the start position BTS_STR_ADDR of the ring buffer 520.

Next, an audio frame (i) is filled in an immediate position after the end position of the previous audio frame (i−1) and further it determines whether a total length of the audio frames filled in the ring buffer 520 is greater than the BTS_MAX_LEN signal or not. If the total length filled is not greater than the BTS_MAX_LEN signal, it indicates that the ring buffer 520 still has room for the audio frames to be stored. In this case, the audio frame (i) is written in the ring buffer 520, and next audio frame (i+1) is processed for repeating such a check. If the total length filled is greater than the BTS_MAX_LEN signal, it indicates the ring buffer 520 has no room to be filled with any complete audio frame. In this case, an end position of the last audio frame filled in the ring buffer 520 is regarded as the end position (BTS_END_ADDR) of the ring buffer 520. This BTS_END_ADDR is output to the decoder 530. The audio frame (i+1) to be filled in the ring buffer 520 returns to the start position, i.e., BTS_STR_ADDR, of the ring buffer 520 to re-start the filling.

The decoder 530 receives the BTS_END_ADDR and accordingly reads the audio frames in the ring buffer 520 from the BTS_STR_ADDR to the BTS_END_ADDR in successive and decodes each audio frame read to thus produce a PCM audio data. When the BTS_END_ADDR is reached, the process returns to the BTS_STR_ADDR.

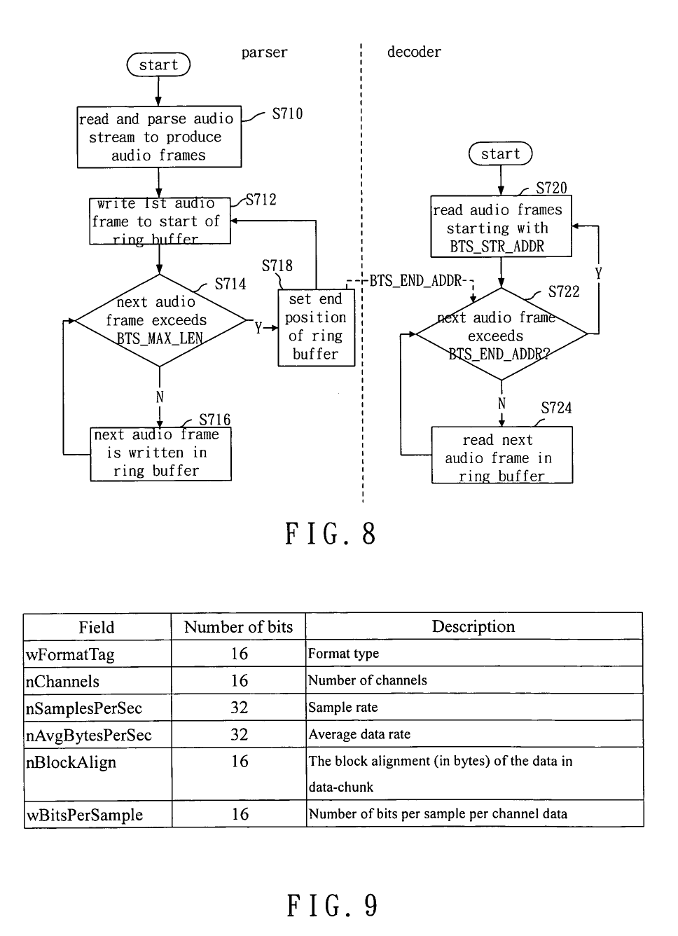

FIG. 8 is a flowchart of an audio decoding method according to the invention. As shown in FIG. 8, in step S710, the parser 510 reads the audio stream and parses it to produce audio frames. Step S712 writes the first audio frame produced to a start position of the ring buffer 520. The start position of the ring buffer 520 is indicated by a BTS_STR_ADDR signal. Also, a BTS_END_ADDR signal records an end position of the audio frames stored, and a BTS_MAX_LEN signal records the maximum length of the ring buffer 520.

Step S714 determines if a next audio frame to be filled in the ring buffer 520 exceeds the length BTS_MAX_LEN; if no, it indicates that the ring buffer 520 has room to store the next audio frame. Thus, the next audio frame is written in the ring buffer 520 (step S716) and next step S714 is executed. Conversely, it indicates that a complete audio frame cannot be filled in the ring buffer 520. Thus, step S718 is executed to set an end position of the ring buffer 520, which uses the end position of the last audio frame filled in the ring buffer 520 as the end position (BTS_END_ADDR) of the ring buffer 520.

In step S720, the decoder 520 reads the audio frames starting with the start position (BTS_STR_ADDR) of the ring buffer 520 and decodes the audio frames read to thus produce PCM audio data. Step S722 determines if a next audio frame to be fetched exceeds an end position of the ring buffer 520 output by the parser 510; if yes, the process returns to step S720; if not, step S724 is executed. The decoder 530 reads a next audio frame in the ring buffer 520 in step S724 and next returns to step S722.

FIG. 9 is a schematic diagram of associated information included in a format chunk of a wave header in a WAVE file. As shown in FIG. 9, a ‘nBlockAlign’ field indicates a block alignment of audio data in a data chunk. Such a block size is a basic decoding unit. The parser 510 receives and parses a WAVE stream to produce multiple basic decoding units and write them to the ring buffer 520 one by one. The decoder 530 reads the basic decoding units in the ring buffer for decoding, thereby producing PCM audio data, as shown in the flowchart of FIG. 8.

As cited, the invention implements a ring buffer 520 between the parser 510 and the decoder 530 such that, by virtue of parsing the associated information (such as the LPCM associated information 222) in the audio stream and using a synchronization mechanism implied in the start position (BTS_STR_ADDR) of the ring buffer 520, when the decoder 530 returns to the BTS_STR_ADDR every time, it can decode a complete audio frame since the parser 510 certainly fills a complete audio frame, and thus the parser can maintain a synchronization between an LPCM audio decoder and an LPCM stream, thereby avoiding the prior problems of data amount and transmission bandwidth increases.

Although the present invention has been explained in relation to its preferred embodiment, it is to be understood that many other possible modifications and variations can be made without departing from the spirit and scope of the invention as hereinafter claimed.

What is claimed is:

1. An audio decoding system with a ring buffer, which receives an audio stream and maintains it in synchronization, the audio stream having multiple basic decoding units, the system comprising:
a ring buffer, which stores the multiple basic decoding units;
a parser, which parses the audio stream to produce the multiple basic decoding units in successive and writes the basic decoding units produced to the ring buffer one by one, wherein a start position of the first basic decoding unit in the ring buffer is aligned at a start position of the ring buffer, and an end position of the ring buffer, after being dynamically adjusted such that the ring buffer has a length which is a multiple of a data length of a basic decoding unit, is output; and
a decoder, which receives the end position and accordingly reads the basic decoding units successively from the start position of the ring buffer to the end position for sound decoding.

2. The system as claimed in claim 1, wherein the audio stream has a format of Linear Pulse Code Modulation (LPCM).

3. The system as claimed in claim 2, wherein each of the basic decoding units is a group of audio frames (GOFs), an audio frame or a complete audio sampling data.

4. The system as claimed in claim 1, wherein the audio stream has a format of WAVE file.

5. The system as claimed in claim 4, wherein each of the basic decoding unit has a unit size defined by a ‘nBlockAlign’ field of a wave header in the format of WAVE file.

6. An audio decoding method, which receives an audio stream and maintains it in synchronization, the audio stream having multiple basic decoding units, using a ring buffer to temporarily store the basic decoding units, the method comprising:
a parsing step, which parses the audio stream to produce the multiple basic decoding units in successive and writes the basic decoding units produced to the ring buffer one by one, wherein a start position of the first basic decoding unit in the ring buffer is aligned at a start position of the ring buffer, and an end position of the ring buffer, after being dynamically adjusted such that the ring buffer has a length which is a multiple of a data length of a basic decoding unit, is output; and
a decoding step, which receives the end position and accordingly reads the basic decoding units successively from the start position of the ring buffer to the end position for sound decoding.

7. The method as claimed in claim 6, wherein the audio stream has a format of Linear Pulse Code Modulation (LPCM).

8. The method as claimed in claim 7, wherein each of the basic decoding units is a group of audio frames (GOFs), an audio frame or a complete audio sampling data.

9. The method as claimed in claim 6, wherein the audio stream has a format of WAVE file.

10. The method as claimed in claim 9, wherein each of the basic decoding unit has a unit size defined by a ‘nBlockAlign’ field of a wave header in the format of WAVE file.
